(19) United States
(12) Patent Application Publication
(10) Pub. No.: US 2010/0043835 A1
(43) Pub. Date: Feb. 25, 2010

(54) SUBSTRATE PROCESSING APPARATUS, SUBSTRATE PROCESSING METHOD, PROGRAM, AND STORAGE MEDIUM

(75) Inventors: Kazuyoshi ESHIMA, Tosu-Shi (JP); Keisuke Sasaki, Koshi-Shi (JP); Hiroshi Komiya, Tosu-Shi (JP)

Correspondence Address: BURR & BROWN, PO BOX 7068, SYRACUSE, NY, 13261-7068, US

(73) Assignee: Tokyo Electron Limited, Minato-Ku (JP)

(21) Appl. No.: 12/546,088

(22) Filed: Aug. 24, 2009

(30) Foreign Application Priority Data
Aug. 25, 2008 (JP) 2008-215422
Aug. 25, 2008 (JP) 2008-215435

(51) Int. Cl. B08B 3/08; B08B 13/00

(52) U.S. Cl. 134/26; 134/95.1

(57) ABSTRACT

A second line 44 is branched from a first line 22 connected to a processing part 10 configured to process a wafer W. A plurality of third lines (an ammonia-water supply line 48, a hydrochloric-acid supply line 52, and a hydrofluoric-acid line 56) are branched from the second line 44. The third lines are respectively provided with valves 48a, 52a, and 56a at locations branched from the second line 44. Chemical-liquid supply sources (an ammonia-water supply source 46, a hydrochloric-acid supply source 50, and a hydrofluoric-acid supply source 54) are connected to the respective third lines, whereby chemical liquids can be supplied from these chemical-liquid supply sources to the respective third lines.

### FIELD OF THE INVENTION

The present invention relates to a substrate processing apparatus configured to perform a chemical liquid process and a rinse process to a substrate, a substrate processing method performed by the substrate processing apparatus, a program executable by a control computer of the substrate processing apparatus, and a storage medium storing the program. Particularly, the present invention relates to a substrate processing apparatus, a substrate processing method, a program, and a storage medium which can reduce installation spaces of valves provided in respective chemical-liquid supply sources.

### BACKGROUND ART

There has been conventionally known a substrate processing apparatus that performs a chemical liquid process and a rinse process to a substrate. As an example of such a substrate processing apparatus, an apparatus disclosed in JP2002-100605A is known, for example.

A structure of the conventional substrate processing apparatus as disclosed in JP2002-100605A is described with reference to FIG. 3. As shown in FIG. 3, in a conventional substrate processing apparatus 80, there is provided a processing tank 81 capable of receiving a wafer W and performing a chemical liquid process and a rinse process to the wafer W received therein. A plurality of, e.g., four supply nozzles 81a are disposed on an inside wall surface of the processing tank 81. Each of the supply nozzles 81a is formed of a cylindrical supply pipe, and is provided in its cylindrical surface with a plurality of discharge holes for discharging a process liquid such as a deionized water and a chemical liquid. By discharging a process liquid such as a deionized water and a chemical liquid into the processing tank 81 from the plurality of discharge holes formed in the respective supply nozzles 81a, the processing tank 81 is filled with the process liquid. Then, by immersing a wafer W into the process liquid stored in the processing tank 81, a surface of the wafer W can be processed.

In addition, a recovery part 81b is disposed on an upper-end outside wall surface of the processing tank 81. The recovery part 81b is adapted to recover a process liquid overflowing from an upper end of the processing tank 81. The process liquid recovered by the recovery part 81b is again sent to the respective supply nozzles 81a by a circulation pump 82. In this manner, the process liquid in the processing tank 81 can be circulated by the circulation pump 82.

On the other hand, a new-liquid supply line 80a, which supplies new process liquids to the processing tank 81, is provided with a plurality of liquid supply sources and valves. To be specific, as shown in FIG. 3, by opening a valve 83 and a valve 84, a new deionized water can be supplied from a deionized-water supply source 85 to the processing tank 81. A supply rate of the deionized water is adjusted by a regulator 85a. In addition, by opening the valve 83 and a valve 86, a cleaning liquid such as an ozone water and a hydrogen water can be supplied from a cleaning-liquid supply source 87 to the processing tank 81. A flowmeter 83a is configured to measure a flow rate of a deionized water or a cleaning water passing therethrough.

In addition, by opening a valve 91a, hydrochloric acid can be supplied from a hydrochloric-acid (HCl) supply source 91 to the processing tank 81. Similarly, by opening a valve 92a, an ammonia water can be supplied thereto from an ammonia-water (NH₄OH) supply source 92. By opening a valve 93a, hydrofluoric acid can be supplied thereto from a hydrofluoric-acid (HF) supply source 93. By opening a valve 94a, a hydrogen peroxide water can be supplied thereto from a hydrogen-peroxide-water (H₂O₂) supply source 94. Supply rates of the respective hydrochloric acid, the ammonia water, the hydrofluoric acid, and the hydrogen peroxide water can be adjusted by flow-rate adjusting valves 91b, 92b, 93b, and 94b. Each of the valves 91a, 92a, 93a, 94a, is structured as an integral mixing valve. A structure of such an integral mixing valve is disclosed in JP2005-207496A, for example. The structure of the integral mixing valve is described below with reference to FIG. 4.

In an integral mixing valve 110 as shown in FIG. 4, a plurality of (two in FIG. 4) sub-channels 114 (a first sub-channel 114A and a second sub-channel 114B) are connected to a main channel 113 via open-close valve parts 120A and 120B that open and close communication openings 118A and 118B of the first sub-channel 114A and the second sub-channel 114B. Pressure sensors 131, 132, and 133 are disposed in the main channel 113, the sub-channel 114A, and the sub-channel 114B, respectively. In FIG. 4, the reference number 111 depicts a body block, and the reference number 112 depicts a valve block.

The main channel 113 is a channel through which a first fluid (e.g., a deionized water) f1 flows. As shown in FIG. 4, the main channel 113 passes substantially horizontally through the body block 111 of a substantially rectangular parallelepiped shape in a longitudinal direction of the body block 111. Opposed ends, i.e., a connection opening 113a (upstream side) and a connection opening 113b (downstream side) of the main channel 113 are connected to external pipes or fluid instruments via connection members, not shown. On a position downstream the communication openings 118A and 118B of the sub-channels 114A and 114B (on a side of the connection opening 113b), the main channel 113 has a pressure sensor 131 configured to detect a pressure of a mixed fluid m flowing through the main channel 113.

The sub-channels 114 (the first sub-channel 114A and the second sub-channel 114B) are channels through which other fluids (chemical liquids), i.e., a second fluid f2 and a third fluid f3 flow. The sub-channels 114 are respectively formed below the main channel 113. The first sub-channel 114A and the second sub-channel 114B are adapted to supply upward the second fluid f2 and the third fluid f3 to the main channel 113 through the communication openings 118A and 118B. In the respective sub-channels 114A and 114B, there are formed choke parts 117A and 117B at which diameters of the channels are once reduced. The choke parts 117A and 117B form pressure loss parts of the respective fluids f2 and f3 flowing through the respective sub-channels 114A and 114B. The reference numbers 115A and 115B in FIG. 4 depict connection openings of the respective sub-channels 114A and 114B, which are connected to external pipes.

The first sub-channel 114A has a pressure sensor 132 configured to detect a pressure of the second fluid f2 flowing through the first sub-channel 114A, and the second sub-channel 114B is has a pressure sensor 133 configured to detect a pressure of the third fluid f3 flowing through the second sub-channel 114B.

The open-close valve parts 120A and 120B are disposed above the communication openings 118A and 118B of the main channel 113. Valve bodies 124 of the open-close valve parts 120A and 120B are actuated by an air or the like by a not-shown control apparatus so as to be moved across the main channel 113, whereby the corresponding communication holes 118A and 118B are opened or closed from the inside of the main channel 113. Thus, the fluids f2 and f3 flowing from the respective sub-channels 114A and 114B can be supplied to the main channel 113, or the supply thereof can be stopped. The reference number 121 in FIG. 4 depicts a cylinder. Similarly, the reference number 122 depicts a piston. The reference number 126 depict a valve seat formed on each of the communication holes 118A and 118B. The reference number 127 depicts a diaphragm. The reference number 128 depicts spring that always presses the valve body 124 forward.

In the integral mixing valve 10 as shown in FIG. 4, the first fluid f1 flowing from the upstream side (from the connection opening 113a) of the main channel 113 is mixed with the respective fluids f2 and f3 supplied from the respective sub-channels 114A and 114B, and is then discharged as a mixed fluid m from the downstream side (from the connection opening 113b) of the main channel 113.

In the substrate processing apparatus 80 shown in FIG. 3, the new-liquid supply line 80a can supply a plural kinds of new process liquids to the processing tank 81. For example, by opening the valve 92a, the valve 94a, the valve 84, and the valve 83, an ammonia water and a hydrogen peroxide water can be mixed with a deionized water, and the mixed liquid can be supplied to the processing tank 81. In addition, by opening the valve 91a, the valve 94a, the valve 84, and the valve 83, a hydrochloric acid and a hydrogen peroxide water can be mixed with a deionized water, and the mixed liquid can be supplied to the processing tank 81. When a mixed liquid of an ammonia water and a hydrogen peroxide water, and a mixed liquid of hydrochloric acid and a hydrogen peroxide water are supplied to the processing tank 81, the chemical liquids are generally mixed with each other, while a deionized water is heated by a heater 85b so that a temperature of the deionized water is raised.

Further, the new-liquid supply line 80a can supply a functional water, such as an ozone water and a hydrogen water, to the processing tank 81. The cleaning-liquid supply source 87 has a function for dissolving ozone or the like in a deionized water so as to generate an ozone water or the like of a predetermined concentration. By opening the valve 86, the thus generated ozone water can be supplied to the processing tank 81. A flow rate of the ozone water or the like is measured by a flowmeter 83a, and is adjusted by opening and closing the valve 86.

### DISCLOSURE OF THE INVENTION

However, in the new-liquid supply line 80a of the conventional substrate processing apparatus 80 as shown in FIG. 3, the respective chemical-liquid lines to which the various chemical liquids are supplied from the respective chemical-liquid supply sources (the hydrochloric-acid supply source 91, the ammonia-water supply source 92, the hydrofluoric-acid supply source 93, and the hydrogen-peroxide-water supply source 94) are directly connected to a main line 88 through which a cleaning liquid, such as a deionized water, an ozone water, and a hydrogen water, is supplied to the processing tank 81. As described above, the valves 91a, 92, 93a, and 94a provided in the locations where the respective chemical-liquid supply lines are branched from the main line 88 are structured as the integral mixing valves.

In the integral mixing valve, four sub-channels 91c, 92c, 93c, and 94c are connected to the main line 88 via the valves 91a, 92a, 93a, and 94a. The valves 91a, 92a, 93a, and 94a are adapted to open and close the four sub-channels 91c, 92c, 93c, and 94c with respect to the main line 88.

The main line 88, which supplies a cleaning liquid such as a deionized water, an ozone water, and a hydrogen water, has a larger diameter. Thus, diameters of the respective valves 91a, 92a, 93a, and 94a constituting the integral mixing valves are also larger.

Therefore, in the conventional substrate processing apparatus 80 as shown in FIG. 3, since the valves 91a, 92a, 93a, and 94a, which are disposed correspondingly to the respective chemical-liquid supply sources (the hydrochloric-acid supply source 91, the ammonia-water supply source 92, the hydrofluoric-acid supply source 93, and the hydrogen-peroxide-water supply source 94) have larger diameters, installation spaces required for these valves 91a, 92a, 93a, and 94a have to be enlarged.

The present invention has been made in view of the above circumstances. The object of the present invention is to provide a substrate processing apparatus, a substrate processing method, a program, and a storage medium, which are capable of reducing installation spaces required for valves provided in respective chemical-liquid supply sources.

A substrate processing apparatus according to the present invention is a substrate processing apparatus comprising: a processing part configured to process a substrate; a first line connected to the processing part and a water supply source, the first line being configured to supply a water sent from the water supply source to the processing part; a second line branched from the first line, the second line being provided with a valve at a location branched from the first line; a plurality of third lines branched from the second line, the third lines being respectively provided with valves at locations branched from the second line; and a plurality of chemical-liquid supply sources connected to the respective third lines, the chemical-liquid supply sources being configured to supply chemical liquids to the respective third lines.

According to such a substrate processing apparatus, the second line is branched from the first line connected to the processing part configured to process a substrate, and the plurality of third lines are branched from the second line. The third lines are respectively provided with the valves at the locations branched from the second line. The chemical-liquid supply sources are connected to the respective third lines, whereby chemical liquids can be supplied from these chemical-liquid supply sources to the third lines. Therefore, since the second line is branched from the first line, the diameter of the second line can be made smaller than the diameter of the first line. In addition, the diameters of the respective valves provided in the third lines can be made substantially the same as or smaller than the diameter of the second line. Accordingly, the diameters of the respective valves provided in the third lines can be made smaller than the diameter of the first line, whereby the installation spaces required for the valves provided in the chemical-liquid supply lines can be reduced.

In the substrate processing apparatus according to the present invention, it is preferable that the respective chemical-liquid supply sources are a hydrofluoric-acid (HF) supply source, a hydrochloric-acid (HCl) supply source, or an ammonia-water (NH₄OH) supply source. In addition, it is preferable that a hydrogen-peroxide-water supply line to which a hydrogen peroxide water (H₂O₂) is supplied is branched from the first line, and that the hydrogen-peroxide-water supply line is provided with a valve at a location branched from the first line.

In the substrate processing apparatus according to the present invention, it is preferable that a fourth line to which a cleaning water is supplied is connected to the second line, and that the fourth line is provided with a valve at a connection location between the fourth line and the second line. In this case, during the rinse process to the substrate, the second line can be cleaned by the cleaning water supplied from the fourth line.

Alternatively, in the substrate processing apparatus according to the present invention, the water supplied from the water supply source to the first line may be discharged from the second line. In this case, during the rinse process of the substrate, the second line can be cleaned by discharging the water, which is supplied from the water supply source to the first line, from the second line.

A substrate processing method according to the present invention is a substrate processing method performed by a substrate processing apparatus including: a processing part configured to process a substrate; a first line connected to the processing part and a water supply source, the first line being configured to supply a water sent from the water supply source to the processing part; a second line branched from the first line, the second line being provided with a valve at a location branched from the first line; a plurality of third lines branched from the second line, the third lines being respectively provided with valves at locations branched from the second line; and a plurality of chemical-liquid supply sources connected to the respective third lines, the chemical-liquid supply sources being configured to supply chemical liquids to the respective third lines; the substrate processing method comprising: performing a chemical liquid process to a substrate in the processing part, by supplying chemical liquids to the processing part by the respective chemical-liquid supply sources through the third lines, the second line, and the first line; and performing a rinse process to the substrate in the processing part after the performance of the chemical liquid process to the substrate, by supplying the water, which is sent from the water supply source to the first line, to the processing part.

In the substrate processing method according to the present invention, it is preferable that a fourth line to which a cleaning water is supplied is connected to the second line, the fourth line being provided with a valve at a connection location between the fourth line and the second line, and that during the rinse process, by opening the valve provided in the fourth line, a cleaning water can be supplied to the processing part from the fourth line through the second line and the first line.

In the substrate processing method according to the present invention, it is preferable that the water supplied from the water supply source to the first line can be discharged from the second line, and that during the rinse process, the water supplied from the water supply source to the first line is discharged from the second line.

A program according to the present invention is a program executable by a control computer of a substrate processing apparatus including: a processing part configured to process a substrate; a first line connected to the processing part and a water supply source, the first line being configured to supply a water sent from the water supply source to the processing part; a second line branched from the first line, the second line being provided with a valve at a location branched from the first line; a plurality of third lines branched from the second line, the third lines being respectively provided with valves at locations branched from the second line; and a plurality of chemical-liquid supply sources connected to the respective third lines, the chemical-liquid supply sources being configured to supply chemical liquids to the respective third lines; upon execution of the program, the control computer controlling the substrate processing apparatus to implement a substrate processing method comprising: performing a chemical liquid process to a substrate in the processing part, by supplying chemical liquids to the processing part by the respective chemical-liquid supply sources through the third lines, the second line, and the first line; and performing a rinse process to the substrate in the processing part after the performance of the chemical liquid process to the substrate, by supplying the water, which is sent from the water supply source to the first line, to the processing part.

A storage medium according to the present invention is a storage medium storing a program executable by a control computer of a substrate processing apparatus including: a processing part configured to process a substrate; a first line connected to the processing part and a water supply source, the first line being configured to supply a water sent from the water supply source to the processing part; a second line branched from the first line, the second line being provided with a valve at a location branched from the first line; a plurality of third lines branched from the second line, the third lines being respectively provided with valves at locations branched from the second line; and a plurality of chemical-liquid supply sources connected to the respective third lines, the chemical-liquid supply sources being configured to supply chemical liquids to the respective third lines; upon execution of the program, the control computer controlling the substrate processing apparatus to implement a substrate processing method comprising: performing a chemical liquid process to a substrate in the processing part, by supplying chemical liquids to the processing part by the respective chemical-liquid supply sources through the third lines, the second line, and the first line; and performing a rinse process to the substrate in the processing part after the performance of the chemical liquid process to the substrate, by supplying the water, which is sent from the water supply source to the first line, to the processing part.

As described above, according to the substrate processing apparatus, the substrate processing method, the program, and the storage medium of the present invention, the installation spaces required for the valves provided in the respective chemical-liquid supply sources can be reduced.

### BRIEF DESCRIPTION OF THE DRAWINGS

FIG. 1 is a structural view schematically showing a structure of a substrate processing apparatus in a first embodiment of the present invention.

FIG. 2 is a structural view schematically showing a structure of the substrate processing apparatus in a second embodiment of the present invention.

FIG. 3 is a structural view showing a structure of a conventional substrate processing apparatus.

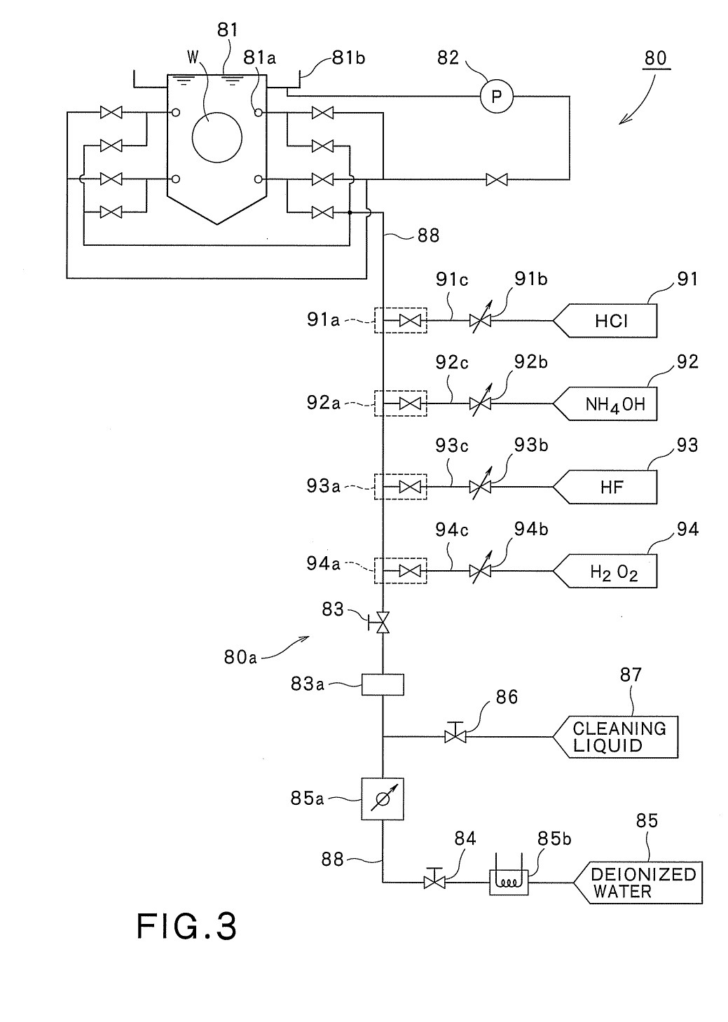

FIG. 4 is a view showing a structure of an integral mixing valve.

### EMBODIMENTS FOR CARRYING OUT THE INVENTION

### First Embodiment

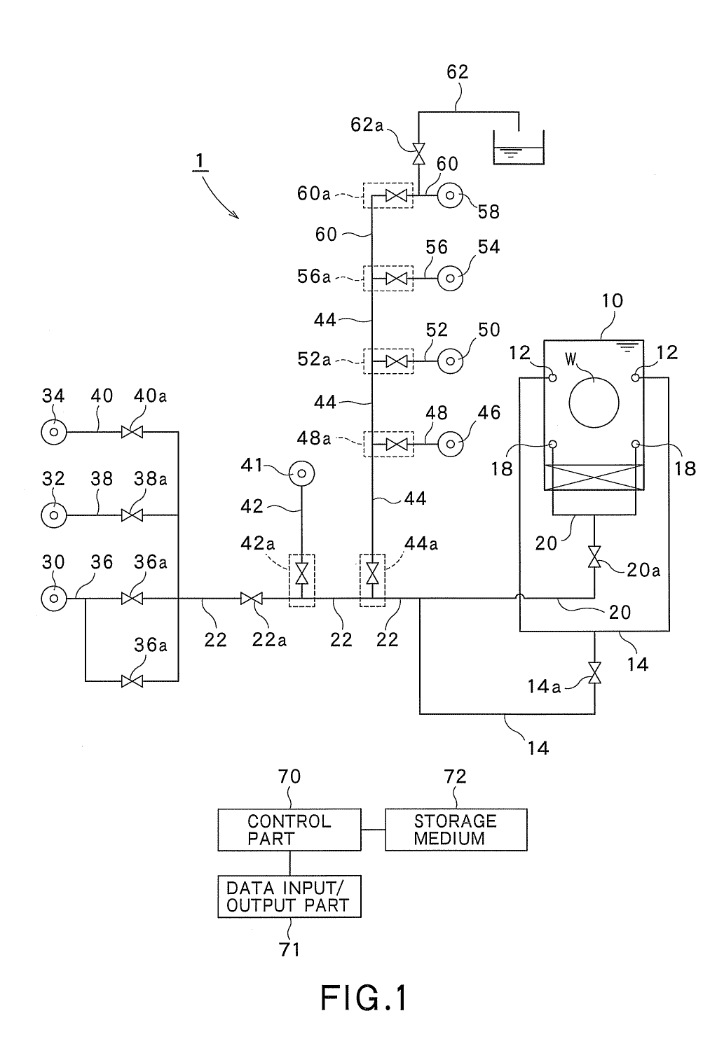

A first embodiment of the present invention will be described below with reference to the drawings. FIG. 1 is a view showing a substrate processing apparatus in a first embodiment. More specifically, FIG. 1 is a structural view schematically showing a structure of the substrate processing apparatus in the first embodiment.

As shown in FIG. 1, a substrate processing apparatus 1 in the first embodiment includes a processing tank 10 capable of receiving a wafer W and performing a chemical liquid process and a rinse process to the wafer W received therein. Four supply nozzles 12 and 18 are disposed on an inside wall surface of the processing tank 10. Each of the supply nozzles 12 and 18 is formed of a cylindrical supply pipe, and is provided in its cylindrical surface with a plurality of discharge holes for discharging a process liquid such as a deionized water and a chemical liquid. By discharging a process liquid such as a deionized water and a chemical liquid into the processing tank 10 from the plurality of discharge holes formed in the respective supply nozzles 12 and 18, the processing tank 10 is filled with the process liquid. Then, by immersing a wafer W into the process liquid stored in the processing tank 10, a surface of the wafer W can be processed.

Out of the four supply nozzles 12 and 18 disposed on the inside wall surface of the processing tank 10, the pair of right and left supply nozzles 12, which are located on an upper part of the processing tank 10, are respectively connected to a supply pipe 14. A process liquid can be supplied from the supply pipe 14 to the respective supply nozzles 12. As shown in FIG. 1, the supply pipe 14 is provided with a valve 14a. Similarly, out of the four supply nozzles 12 and 18 disposed on the inside wall surface of the processing tank 10, the pair of right and left supply nozzles 18, which are located on a lower part of the processing tank 10, are respectively connected to a supply pipe 20. A process liquid can be supplied from the supply pipe 20 to the respective supply nozzles 18. As shown in FIG. 1, the supply pipe 20 is provided with a valve 20a. The supply pipe 14 and the supply pipe 20 are merged with each other, and a first line 22 is connected to the merged location. Namely, a process liquid can be supplied from the first line 22 to the respective supply pipes 14 and 20. A diameter of a pipe of the first line 22 is, e.g., about 1.5 inches.

On an upstream end of the first line 22, there are disposed a deionized-water (DIW) supply source 30, an ozone-water (O₃W) supply source 32, and a hot-water (HDIW more strictly, heated deionized water) supply source 34. To be specific, a deionized-water supply line 36 is connected to the deionized-water supply source 30, whereby a deionized water can be supplied from the deionized-water supply source 30 to the deionized-water supply line 36. A diameter of the deionized-water supply line 36 is, e.g., about 1.5 inches. As shown in FIG. 1, the deionized-water supply line 36 is branched into two pipes. The two branched pipes are respectively provided with valves 36a. A diameter of each of the two branched pipes is, e.g., about 1 inches, and a diameter of each valve 36a is also, e.g., about 1 inches.

An ozone-water supply line 38 is connected to the ozone-water supply source 32, whereby an ozone water can be supplied from the ozone-water supply source 32 to the ozone-water supply line 38. The ozone-water supply line 38 is provided with a valve 38a. A diameter of the ozone-water supply line 38 is, e.g., about 1 inches, and a diameter of the valve 38a is also, e.g., about 1 inches. In addition, a hot-water supply line 40 is connected to the hot-water (HDIW) supply source 34, whereby a heated deionized water can be supplied from the hot-water supply source 34 to the hot-water supply line 40. The hot-water supply line 40 is provided with a valve 40a. A diameter of the hot-water supply line 40 is, e.g., about 1 inches, and a diameter of the valve 40a is also, e.g., about 1 inches.

The two pipes branched from the deionized-water supply line 36, the ozone-water supply line 38, and the hot-water supply line 40 are merged with each other at one location, and the upstream end of the first line 22 is connected to the merged location. Namely, a deionized water, an ozone water, and a hot water can be supplied to the first line 22 from the deionized-water supply source 30, the ozone-water supply source 32, and the hot-water supply source 34.

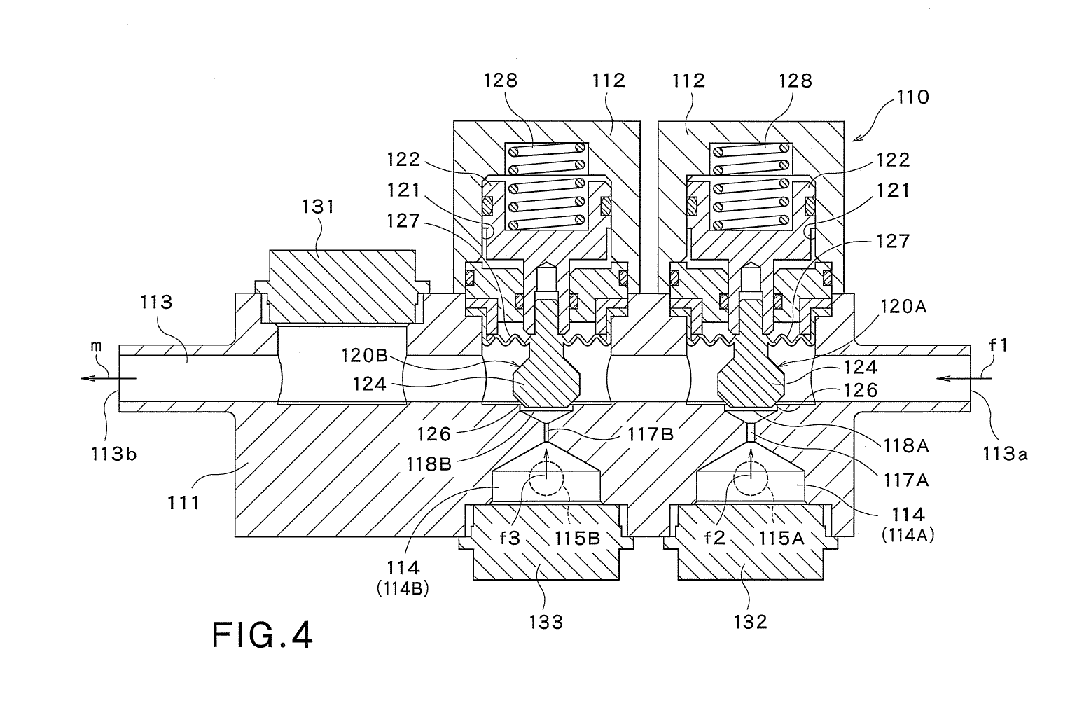

As shown in FIG. 1, the first line 22 is provide with a valve 22a. The diameter of the first line 22 is, e.g., about 1.5 inches, and a diameter of the valve 22a is also, e.g., about 1.5 inches. A hydrogen-peroxide-water (H₂O₂) supply line 42 and a second line 44 are respectively connected to the first line 22 at a position downstream the valve 22a. A hydrogen-peroxide-water supply source 41 is disposed on an upstream end of the hydrogen-peroxide-water supply line 42, whereby a hydrogen peroxide water can be sent from the hydrogen-peroxide-water supply source 41 to the hydrogen-peroxide-water supply line 42. Various chemical-liquid supply sources are disposed on an upstream end of the second line 44. Details of the structure of the second line 44 are described hereafter. A valve 42a is disposed at a connection location between the hydrogen-peroxide-water supply line 42 and the first line 22, and a valve 44a is disposed at a connection location between the second line 44 and the first line 22. The valves 42a and 44a are structured as the integral mixing valves as shown in FIG. 4. Diameters of the valves 42a and 44a are, e.g., about 1.5 inches which is the same as the diameter of the first line 22.

A diameter of the second line 44 is smaller than the diameter of the first line 22, and is, e.g., about ⅜ inches or 0.5 inches. An ammonia-water (NH₄OH) supply line 48, a hydrochloric-acid (HCl) supply line 52, and a hydrofluoric-acid (HF) supply line 56 are respectively branched from the second line 44. An ammonia-water supply source 46 is connected to the ammonia-water supply line 48, whereby an ammonia water can be supplied from the ammonia-water supply source 46 to the ammonia-water supply line 48. A hydrochloric-acid supply source 50 is connected to the hydrochloric-acid supply line 52, whereby hydrochloric acid can be supplied from the hydrochloric-acid supply source 50 to the hydrochloric-acid supply line 52. A hydrofluoric-acid supply source 54 is connected to the hydrofluoric-acid supply line 56, whereby hydrofluoric acid can be supplied from the hydrofluoric-acid supply source 54 to the hydrofluoric-acid supply line 56. These ammonia-water supply line 48, the hydrochloric-acid supply line 52, and the hydrofluoric-acid supply line 56 respectively constitute third lines.

A fourth line 60 is connected to an upstream end of the second line 44. A cleaning-deionized-water supply source 58 is connected to the fourth line 60, whereby a deionized water for cleaning can be supplied from the cleaning-deionized-water supply source 58 to the fourth line 60, so that the second line 44, and the valves 56a, 52a, 48a, and 44a (described below) can be cleaned. A drain pipe 62 is branched from the fourth line 60, and a process liquid can be discharged from the fourth line 60 by the drain pipe 62. The drain pipe 62 may be provided with a valve 62a, so as to discharge a process liquid from the fourth line 60 by the drain pipe 62, when the valve 62a is opened.

A valve 60a is disposed at a connection location between the fourth line 60 and the second line 44. The valve 48a is disposed at a connection location between the ammonia-water supply line 48 and the second line 44. The valve 52a is disposed at a connection location between the hydrochloric-acid supply line 52 and the second line 44. The valve 56a is disposed at a connection location between the hydrofluoric-acid supply line 56 and the second line 22. The valves 60a, 48a, 52a, and 56a are structured as the integral mixing valves as shown in FIG. 4. Similarly to the diameter of the second line 44, diameters of the valves 60a, 48a, 52a, and 56a are, e.g., about ⅜ inches or 0.5 inches.

The substrate processing apparatus 1 is equipped with a control part 70 formed of a control computer that controls various elements in the substrate processing apparatus 1. The control part 70 is connected to the respective elements of the substrate processing apparatus 1, whereby a chemical liquid process and a rinse process to a wafer W in the processing tank 10 are controlled by the control part 70. More specifically, the control part 70 controls the supply of a deionized water and chemical liquids from the respective supply sources 30, 32, 34, 41, 46, 50, 54, and 58. Further, the control part 70 controls an opening and closing operation of the respective valves 14a, 20a, 22a, 36a, 38a, 40a, 42a, 44a, 48a, 52a, 56a, 60a, and 62a. The control of the respective elements of the substrate processing apparatus 1 by the control part 70 is described hereafter. In the first embodiment, connected to the control part 70 are a keyboard through which a process manager can input commands for managing the substrate processing apparatus 1, and a data input/output part 71 formed of a display or the like that visualizes a working condition of the substrate processing apparatus 1. In addition, connected to the control part 70 are a control program for implementing various processes performed by the substrate processing apparatus 1 under the control of the control part 70, and a storage medium 72 storing a program (i.e., recipe) for causing respective elements of the substrate processing apparatus 1 to perform processes depending on process conditions. The storage medium 72 may be structured from a memory such as a ROM and a RAM, a hard disc, a disc-shaped storage medium such as a CD-ROM and a DVD-ROM, and another publicly known storage medium.

According to need, a given recipe is read out from the storage medium 72 by a command from the data input/output part 71, and the recipe is executed by the control part 70. Thus, under the control of the control part 70, a desired process can be performed by the substrate processing apparatus 1.

Next, a method of processing a wafer W with the use of the aforementioned substrate processing apparatus 1 is described. The following series of chemical liquid processes and rinse processes are performed while the control part 70 controls the respective elements of the substrate processing apparatus 1 in line with the program (recipe) stored in the storage medium 72.

At first, a waiting state before the performance of a chemical liquid process and a rinse process to a wafer W in the processing tank 10 is described. Under this waiting state, the valves 36a, 22a, and 20a are opened by the control part 70, so that a deionized water is supplied from the deionized-water supply source 30 to the deionized-water supply line 36, whereby the deionized water is supplied into the processing tank 10 by the supply nozzles 18 through the first line 22 and the supply pipe 20.

Then, a chemical liquid process is performed to the wafer W in the processing tank 10. Although there are many types of chemical liquid processes, in a first aspect of the chemical liquid process, the valves 36a, 22a, 44a, 56a, 20a, and 14a are opened by the control part 70, so that a deionized water is supplied from the deionized-water supply source 30 to the deionized-water supply line 36, and that hydrofluoric acid is supplied from the hydrofluoric-acid supply source 54 to the hydrofluoric-acid supply line 56. The hydrofluoric acid supplied from the hydrofluoric-acid supply source 54 is diluted with the deionized water in the first line 22, and the hydrofluoric acid diluted with the deionized water is supplied into the processing tank 10 by the supply nozzles 12 and 18 through the supply pipes 14 and 20. Thus, the hydrofluoric acid diluted with the deionized water is supplied to a surface of the wafer W received in the processing tank 10, whereby the surface of the wafer W is subjected to the chemical liquid process.

Next, a second aspect of the chemical liquid process is described. In the second aspect of the chemical liquid process, the valves 40a, 22a, 42a, 44a, 48a, and 20a are opened by the control part 70, so that a hot water is supplied from the hot-water supply source 34 to the hot-water supply line 40, that a hydrogen peroxide water is supplied from the hydrogen-peroxide-water supply source 41 to the hydrogen-peroxide-water supply line 42, and that an ammonia water is supplied from the ammonia-water supply source 46 to the ammonia-water supply line 48. The hydrogen peroxide water supplied from the hydrogen-peroxide-water supply source 41 is diluted with the hot water in the first line 22, and the hydrogen peroxide water diluted with the hot water is mixed with the ammonia water in the first line 22. Then, the mixed liquid of the hydrogen peroxide water and the ammonia water is supplied into the processing tank 10 by the supply nozzles 18 through the supply pipe 20. Thus, the mixed liquid of the hydrogen peroxide water and the ammonia water is supplied to the surface of the wafer W received in the processing tank 10, whereby the surface of the wafer W is subjected to the chemical liquid process.

Next, a third aspect of the chemical liquid process is described. In the third aspect of the chemical liquid process, the valves 36a, 38a, 22a, 44a, 56a, 14a, and 20a are opened by the control part 70, so that a deionized water is supplied from the deionized-water supply source 30 to the deionized-water supply line 36, that an ozone water is supplied from the ozone-water supply source 32 to the ozone-water supply line 38, and that hydrofluoric acid is supplied from the hydrofluoric-acid supply source 54 to the hydrofluoric-acid supply line 56. The ozone water supplied from the ozone-water supply source 32 is diluted with the deionized water in the first line 22, and the ozone water diluted with the deionized water is mixed with the hydrofluoric acid in the first line 22. Then, the mixed liquid of the ozone water and the hydrofluoric acid is supplied into the processing tank 10 by the supply nozzles 12 and 18 through the supply pipes 14 and 20. Thus, the mixed liquid of the ozone water and the hydrofluoric acid is supplied to the surface of the wafer W received in the processing tank 10, whereby the surface of the wafer W is subjected to the chemical liquid process.

Next, rinse processes to a wafer W after the performance of the aforementioned chemical liquid process to a wafer W is described. Although there are many types of rinse processes, in a first aspect of the rinse process, the valves 36a, 22a, 44a, 60a, 14a, and 20a are opened by the control part 70, so that a deionized water is supplied from the deionized-water supply source 30 to the deionized-water supply line 36, and that a deionized water is supplied from the cleaning-deionized-water supply source 58 to the fourth line 60. The second line 44 is cleaned by the deionized water supplied from the cleaning-deionized-water supply source 58, and the first line 22 is cleaned by the deionized water supplied from the deionized-water supply source 30. Then, both the deionized waters are merged in the first line 22, and are finally supplied into the processing tank 10 by the supply nozzles 12 and 18 through the supply pipes 14 and 20. Thus, the deionized waters are supplied to the surface of the wafer W received in the processing tank 10, whereby the surface of the wafer W is subjected to the rinse process.

Next, a second aspect of the rinse process is described. In the second aspect of the rinse process, the valves 40a, 22a, 44a, 60a, and 20a are opened by the control part 70, so that a heated deionized water is supplied from the hot-water supply source 34 to the hot-water supply line 40, and that a deionized water is supplied from the cleaning-deionized-water supply source 58 to the fourth line 60. The second line 44 is cleaned by the deionized water supplied from the cleaning-deionized-water supply source 58, and the first line 22 is cleaned by the hot water supplied from the hot-water supply source 34. Then, both the deionized waters are merged in the first line 22, and are finally supplied into the processing tank 10 by the supply nozzles 18 through the supply pipe 20. Thus, the deionized waters are supplied to the surface of the wafer W received in the processing tank 10, whereby the surface of the wafer W is subjected to the rinse process.

In the above rinse processes, when the valve 62a is opened by the control part 70, the deionized waters supplied from the deionized-water supply source 30 and the hot-water supply source 34 can be discharged by the drain pipe 62 from the fourth line 60 through the second line 44. Thus, the second line 44, the valves 56a, 52a, 48a, and 44a, and the supply pipe 20 can be cleaned. As a result, no chemical liquid remains on the pipes and the valves, another chemical liquid process using a different chemical liquid can be continuously performed.

As described above, according to the first embodiment of the substrate processing apparatus 1 and the substrate processing method, the second line 44 is branched from the first line 22 connected to the processing tank 10 configured to process a wafer W, and the plurality of third lines (the ammonia-water supply line 48, the hydrochloric-acid supply line 52, and the hydrofluoric-acid supply line 56) are branched from the second line 44. The third lines are respectively provided with the valves 48a, 52a, and 56a at the locations branched from the second line 44. The chemical-liquid supply sources (the ammonia-water supply source 46, the hydrochloric-acid supply source 50, and the hydrofluoric-acid supply source 54) are connected to the respective third lines, whereby chemical liquids can be supplied from these chemical-liquid supply sources to the third lines. Therefore, since the second line 44 is branched from the first line 22, the diameter of the second line 44 can be made smaller than the diameter of the first line 22. In addition, the diameters of the respective valves 48a, 52a, and 56a provided the third lines can be made substantially the same as or smaller than the diameter of the second line 44. Accordingly, the diameters of the respective valves 48a, 52a, and 56a provided in the third lines can be made smaller than the diameter of the first line 22, whereby the installation spaces required for the valves provided in the chemical-liquid supply lines (third lines) can be reduced.

The fourth line 60, to which a cleaning water is supplied, is connected to the second line 44, and the fourth line 60 is provided with the valve 60a at the connection location between the fourth line 60 and the second line 44. Thus, in the rinse process of a wafer W, the second line 44 can be cleaned by the cleaning water supplied from the fourth line 60.

Moreover, the deionized waters supplied from the deionized-water supply source 30 and the hot-water supply source 34 to the first line 22 can be discharged from the second line 44 by the drain pipe 62. Thus, in the rinse process of a wafer W, the second line 44 can be cleaned by discharging the deionized waters supplied from the deionized-water supply source 30 and the hot-water supply source 34 to the first line 22, instead of using the deionized water for cleaning supplied from the cleaning-deionized-water supply source 58 to the fourth line 60.

The substrate processing apparatus 1 and the substrate processing method in this embodiment are not limited to the above mode, but various changes and modifications are possible. For example, in the substrate processing apparatus 1 as shown in FIG. 1, the provision of the ozone-water supply source 32 and the hot-water supply source 34 can be omitted. Further, the chemical-liquid supply lines to be connected to the second line 44 are not limited to the ammonia-water supply line 48, the hydrochloric-acid supply line 52, and the hydrofluoric-acid supply line 56, but may be another chemical-liquid supply line to which a chemical-liquid supply source for supplying another kind of chemical liquid is connected. Furthermore, in the substrate processing apparatus 1 as shown in FIG. 1, the provision of the fourth line 60 and the cleaning-deionized-water supply source 58 can be omitted. Alternatively, the provision of the drain pipe 62 may be omitted, while the fourth line 60 and the cleaning-deionized-water supply source 58 remain as they are.

### Second Embodiment

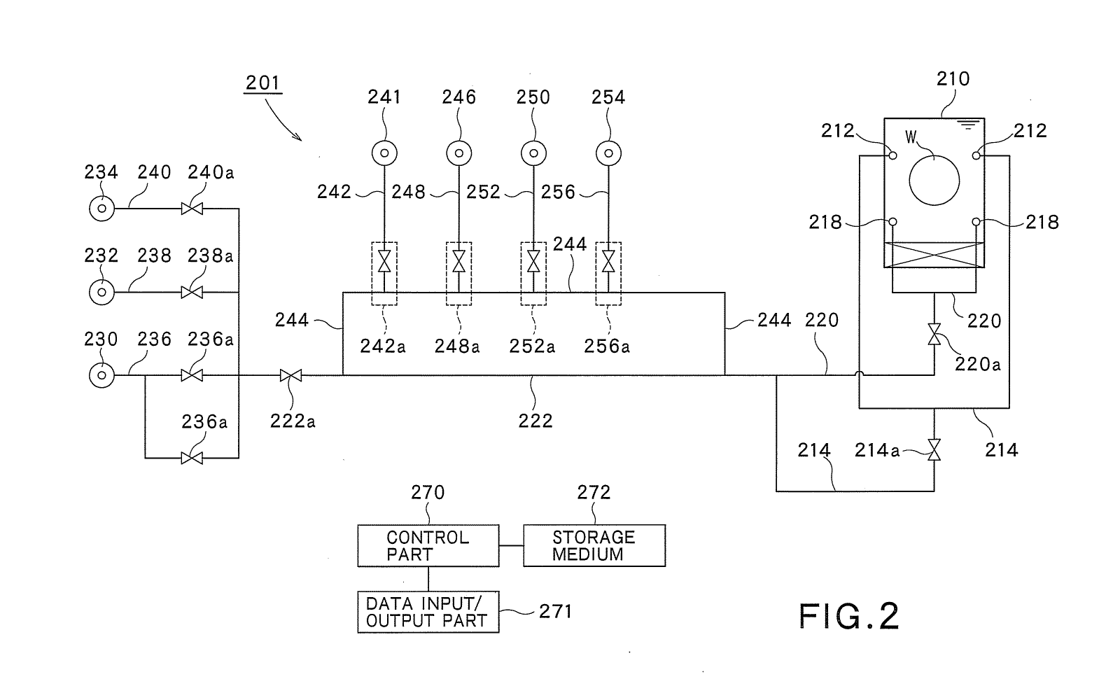

A second embodiment of the present invention will be described below with reference to the drawings. FIG. 2 is a view showing a substrate processing apparatus in a second embodiment. More specifically, FIG. 2 is a structural view schematically showing a structure of the substrate processing apparatus in the second embodiment.

As shown in FIG. 2, a substrate processing apparatus 201 in the second embodiment includes a processing tank 210 capable of receiving a wafer W and performing a chemical liquid process and a rinse process to the wafer W received therein. Four supply nozzles 212 and 218 are disposed on an inside wall surface of the processing tank 210. Each of the supply nozzles 212 and 218 is formed of a cylindrical supply pipe, and is provided in its cylindrical surface with a plurality of discharge holes for discharging a process liquid such as a deionized water and a chemical liquid. By discharging a process liquid such as a deionized water and a chemical liquid into the processing tank 210 from the plurality of discharge holes formed in the respective supply nozzles 212 and 218, the processing tank 210 is filled with the process liquid. Then, by immersing a wafer W into the process liquid stored in the processing tank 210, a surface of the wafer W can be processed.

Out of the four supply nozzles 212 and 218 disposed on the inside wall surface of the processing tank 210, the pair of right and left supply nozzles 212, which are located on an upper part of the processing tank 210, are respectively connected to a supply pipe 214. A process liquid can be supplied from the supply pipe 214 to the respective supply nozzles 212. As shown in FIG. 2, the supply pipe 214 is provided with a valve 214a. Similarly, out of the four supply nozzles 212 and 218 disposed on the inside wall surface of the processing tank 210, the pair of right and left supply nozzles 218, which are located on a lower part of the processing tank 210, are respectively connected to a supply pipe 220. A process liquid can be supplied from the supply pipe 220 to the respective supply nozzles 218. As shown in FIG. 2, the supply pipe 220 is provided with a valve 220a. The supply pipe 214 and the supply pipe 220 are merged with each other, and a first line 222 is connected to the merged location. Namely, a process liquid can be supplied from the first line 222 to the respective supply pipes 214 and 220. A diameter of a pipe of the first line 222 is, e.g., about 1.5 inches.

On an upstream end of the first line 222, there are disposed a deionized-water (DIW) supply source 230, an ozone-water (O₃W) supply source 232, and a hot-water (HDIW more strictly, heated deionized water) supply source 234. To be specific, a deionized-water supply line 236 is connected to the deionized-water supply source 230, whereby a deionized water can be supplied from the deionized-water supply source 230 to the deionized-water supply line 236. A diameter of the deionized-water supply line 236 is, e.g., about 1.5 inches. As shown in FIG. 2, the deionized-water supply lines 236 is branched into two pipes. The two branched pipes are respectively provided with valves 236a. A diameter of each of the two branched pipes is, e.g., about 1 inches, and a diameter of each valve 236a is also, e.g., about 1 inches.

An ozone-water supply line 238 is connected to the ozone-water supply source 232, whereby an ozone water can be supplied from the ozone-water supply source 232 to the ozone-water supply line 238. The ozone-water supply line 238 is provided with a valve 238a. A diameter of the ozone-water supply line 238 is, e.g., about 1 inches, and a diameter of the valve 238a is also, e.g., about 1 inches. In addition, a hot-water supply line 240 is connected to the hot-water (HDIW) supply source 234, whereby a heated deionized water can be supplied from the hot-water supply source 234 to the hot-water supply line 240. The hot-water supply line 240 is provided with a valve 240a. A diameter of the hot-water supply line 240 is, e.g., 1 inches, and a diameter of the valve 240a is also, e.g., about 1 inches.

The two pipes branched from the deionized-water supply line 236, the ozone-water supply line 238, and the hot-water supply line 240 are merged with each other at one location, and the upstream end of the first line 222 is connected to the merged location. Namely, a deionized water, an ozone water, and a hot water can be supplied to the first line 222 from the deionized-water supply source 230, the ozone-water supply source 232, and the hot-water supply source 234.

As shown in FIG. 2, the first line 222 is provided with a valve 222a. The diameter of the first line 222 is, e.g., about 1.5 inches, and a diameter of the valve 222a is also, e.g., about 1.5 inches.

As shown in FIG. 2, an upstream end and a downstream end of the second line 244 are respectively connected to the first line 222. The second line 244 serves as a so-called bypass route of the first line 222.

A diameter of the second line 244 is smaller than the diameter of the first line 222, and is e.g., about ⅜ inches or 0.5 inches. A hydrogen-peroxide-water (H₂O₂) supply line 242, an ammonia-water (NH₄OH) supply line 248, a hydrochloric-acid (HCl) supply line 252, and a hydrofluoric-acid (HF) supply line 256 are respectively branched from the second line 244. A hydrogen-peroxide-water supply source 241 is connected to the hydrogen-peroxide-water supply line 242, whereby a hydrogen peroxide water can be supplied from the hydrogen-peroxide-water supply source 241 to the hydrogen-peroxide-water supply line 242. An ammonia-water supply source 246 is connected to the ammonia-water supply line 248, whereby an ammonia water is supplied from the ammonia-water supply source 246 to the ammonia-water supply line 248. A hydrochloric-acid supply source 250 is connected to the hydrochloric-acid supply line 252, whereby hydrochloric acid can be supplied from the hydrochloric-acid supply source 250 to the hydrochloric-acid supply line 252. A hydrofluoric-acid supply source 254 is connected to the hydrofluoric-acid supply line 256, whereby hydrofluoric acid can be supplied from the hydrofluoric-acid supply source 254 to the hydrofluoric-acid supply line 256. These hydrogen-peroxide-water supply line 242, the ammonia-water supply line 248, the hydrochloric-acid supply line 252, and the hydrofluoric-acid supply line 256 respectively constitute third lines.

A valve 242a is disposed at a connection location between the hydrogen-peroxide-water supply line 242 and the second line 244. A valve 248a is disposed at a connection location between the ammonia-water supply line 248 and the second line 244. A valve 252a is disposed at a connection location between the hydrochloric-acid supply line 252 and the second line 244. A valve 256a is disposed at a connection location between the hydrofluoric-acid supply line 256 and the second line 244. The valves 242a, 248a, 252a, and 256a are structured as the integral mixing valves as shown in FIG. 4. Similarly to the diameter of the second line 244, diameters of the valves 242a, 248a, 252a, and 256a are, e.g., about ⅜ inches or 0.5 inches. However, one of or all of these valves 242a, 248a, 252a, and 256a may not structure the integral mixing valve, and a diameter of the valve that does not structure such an integral mixing valve may be smaller than the diameter of the second line 244.

The substrate processing apparatus 201 is equipped with a control part 270 formed of a control computer that controls various elements in the substrate processing apparatus 201. The control part 270 is connected to the respective elements of the substrate processing apparatus 201, whereby a chemical liquid process and a rinse process to a wafer W in the processing tank 210 are controlled by the control part 270. More specifically, the control part 270 controls the supply of a deionized water and chemical liquids from the respective supply sources 230, 232, 234, 241, 246, 250, and 254. Further, the control part 270 controls an opening and closing operation of the respective valves 214a, 220a, 222a, 236a, 238a, 240a, 242a, 248a, 252a, and 256a. The control of the respective elements of the substrate processing apparatus 201 by the control part 270 is described hereafter. In the second embodiment, connected to the control part 270 are a keyboard through which a process manager can input commands for managing the substrate processing apparatus 201, and a data input/output part 271 formed of a display or the like that visualizes a working condition of the substrate processing apparatus 201. In addition, connected to the control part 270 are a control program for implementing various processes performed by the substrate processing apparatus 201 under the control of the control part 270, and a storage medium 272 storing a program (i.e., recipe) for causing respective elements of the substrate processing apparatus 201 to perform processes depending on process conditions. The storage medium 272 may be structured from a memory such as a ROM and a RAM, a hard disc, a disc-shaped storage medium such as a CD-ROM and a DVD-ROM, and another publicly known storage medium.

According to need, a given recipe is read out from the storage medium 272 by a command from the data input/output part 271, and the recipe is executed by the control part 270. Thus, under the control of the control part 270, a desired process can be performed by the substrate processing apparatus 201.

Next, a method of processing a wafer W with the use of the aforementioned substrate processing apparatus 201 is described. The following series of chemical liquid processes and rinse processes are performed by the control part 270 which controls the respective elements of the substrate processing apparatus 201 in line with the program (recipe) stored in the storage medium 272.

At first, a waiting state before the performance of a chemical liquid process and a rinse process to a wafer W in the processing tank 210 is described. Under this waiting state, the valves 236a, 222a, and 220a are opened by the control part 270, so that a deionized water is supplied from the deionized-water supply source 230 to the deionized-water supply line 236, whereby the deionized water is supplied into the processing tank 210 by the supply nozzles 218 through the first line 222, the second line 244, and the supply pipe 220.

Then, a chemical liquid process is performed to the wafer W in the processing tank 210. Although there are many types of chemical liquid processes, in a first aspect of the chemical liquid process, the valves 236a, 222a, 256a, 220a, and 214a are opened by the control part 270, so that a deionized water is supplied from the deionized-water supply source 230 to the deionized-water supply line 236, and that hydrofluoric acid is supplied from the hydrofluoric-acid supply source 254 to the hydrofluoric-acid supply line 256. The hydrofluoric acid supplied from the hydrofluoric-acid supply source 254 is diluted with the deionized water in the second line 244, and the hydrofluoric acid diluted with the deionized water is supplied into the processing tank 210 by the supply nozzles 212 and 218 through the supply pipes 214 and 220. Thus, the hydrofluoric acid diluted with the deionized water is supplied to a surface of the wafer W received in the processing tank 210, whereby the surface of the wafer W is subjected to the chemical liquid process.

Next, a second aspect of the chemical liquid process is described. In the second aspect of the chemical liquid process, the valves 240a, 222a, 242a, 248a, and 220a are opened by the control part 270, so that a hot water is supplied from the hot-water supply source 234 to the hot-water supply line 240, that a hydrogen peroxide water is supplied from the hydrogen-peroxide-water supply source 241 to the hydrogen-peroxide-water supply line 242, and that an ammonia water is supplied from the ammonia-water supply source 246 to the ammonia-water supply line 248. The hydrogen peroxide water supplied from the hydrogen-peroxide-water supply source 241 is diluted with the hot water in the second line 244, and the hydrogen peroxide water diluted with the hot water is mixed with the ammonia water in the second line 244. Then, the mixed liquid of the hydrogen peroxide water and the ammonia water is supplied into the processing tank 210 by the supply nozzles 218 through the supply pipe 220. Thus, the mixed liquid of the hydrogen peroxide water and the ammonia water is supplied to the surface of the wafer W received in the processing tank 210, whereby the surface of the wafer W is subjected to the chemical liquid process.

Next, a third aspect of the chemical liquid process is described. In the third aspect of the chemical liquid process, the valves 236a, 238a, 222a, 256a, 214a, and 220a are opened by the control part 270, so that a deionized water is supplied from the deionized-water supply source 230 to the deionized-water supply line 236, that an ozone water is supplied from the ozone-water supply source 232 to the ozone-water supply line 238, and that hydrofluoric acid is supplied from the hydrofluoric-acid supply source 254 to the hydrofluoric-acid supply line 256. The ozone water supplied from the ozone-water supply source 232 is diluted with the deionized water in the first line 222, and the ozone water diluted with the deionized water is mixed with the hydrofluoric acid in the second line 244. Then, the mixed liquid of the ozone water and the hydrofluoric acid is supplied into the processing tank 210 by the supply nozzles 212 and 218 through the supply pipes 214 and 220. Thus, the mixed liquid of the ozone water and the hydrofluoric acid is supplied to the surface of the wafer W received in the processing tank 210, whereby the surface of the wafer W is subjected to the chemical liquid process.

Next, rinse processes to a wafer W after the performance of the aforementioned chemical liquid process to a wafer W is described. Although there are many types of rinse processes, in a first aspect of the rinse process, the valves 236a, 222a, 214a, and 220a are opened by the control part 270, so that a deionized water is supplied from the deionized-water supply source 230 to the deionized-water supply line 236. The first line 222 and the second line 244 are cleaned by the deionized water supplied from the deionized-water supply source 230. Then, the deionized water is finally supplied into the processing tank 210 by the supply nozzles 212 and 218 through the supply pipes 214 and 220. Thus, the deionized water is supplied to the surface of the wafer W received in the processing tank 210, whereby the surface of the wafer W is subjected to the rinse process.

Next, a second aspect of the rinse process is described. In the second aspect of the rinse process, the valves 240a, 222a, and 220a are opened by the control part 270, so that a heated deionized water is supplied from the hot-water supply source 234 to the hot-water supply line 240. The first line 222 and the second line 244 are cleaned by the hot water supplied from the hot-water supply source 234. Then, the heated deionized water is finally supplied into the processing tank 210 by the supply nozzles 218 through the supply pipe 220. Thus, the deionized water is supplied to the surface of the wafer W received in the processing tank 210, whereby the surface of the wafer W is subjected to the rinse process.

As described above, according to the second embodiment of the substrate processing apparatus 201 and the substrate processing method, the upstream end and the downstream end of the second line 244 are respectively connected to the first line 222 connected to the processing tank 210 configured to process a wafer W. The plurality of third lines (the hydrogen-peroxide-water supply line 242, the ammonia-water supply line 248, the hydrochloric-acid supply line 252, and the hydrofluoric-acid supply line 256) are branched from the second line 244. The third lines are respectively provided with the valves 242a, 248a, 252a, and 256a at the locations branched from the second line 244. The chemical-liquid supply sources (the hydrogen-peroxide-water supply source 241, the ammonia-water supply source 246, the hydrochloric-acid supply source 250, and the hydrofluoric-acid supply source 254) are connected to the respective third lines, whereby chemical liquids can be supplied from these chemical-liquid supply sources to the third lines. Since the upstream end and the downstream end of the second line 244 are respectively connected to the first line 222 so that the second line 244 serves as a so-called bypass route of the first line 222, the diameter of the second line 244 can be made smaller than the diameter of the first line 222. In addition, the diameters of the respective valves 248a, 252a, and 256a provided in the third lines can be made substantially the same as or smaller than the diameter of the second line 244. Accordingly, the diameters of the respective valves 242a, 248a, 252a, and 256a provided in the third lines can be made smaller than the diameter of the first line 222, whereby the installation spaces required for the valves provided in the chemical-liquid supply lines (third lines) can be reduced.

The substrate processing apparatus 201 and the substrate processing method in this embodiment are not limited to the above mode, but various changes and modifications are possible. For example, in the substrate processing apparatus 201 as shown in FIG. 2, the provision of the ozone-water supply source 232 and the hot-water supply source 234 can be omitted. Further, the chemical-liquid supply lines to be connected to the second line 244 are not limited to the hydrogen-peroxide-water supply line 242, the ammonia-water supply line 248, the hydrochloric-acid supply line 252, and the hydrofluoric-acid supply line 256, but may be another chemical-liquid supply line to which a chemical-liquid supply source for supplying another kind of chemical liquid is connected.

1. A substrate processing apparatus comprising:
a processing part configured to process a substrate;
a first line connected to the processing part and a water supply source, the first line being configured to supply a water sent from the water supply source to the processing part;
a second line branched from the first line, the second line being provided with a valve at a location branched from the first line;
a plurality of third lines branched from the second line, the third lines being respectively provided with valves at locations branched from the second line; and
a plurality of chemical-liquid supply sources connected to the respective third lines, the chemical-liquid supply sources being configured to supply chemical liquids to the respective third lines.

2. The substrate processing apparatus according to claim 1, wherein
the respective chemical-liquid supply sources are a hydrofluoric-acid (HF) supply source, a hydrochloric-acid (HCl) supply source, or an ammonia-water (NH₄OH) supply source.

3. The substrate processing apparatus according to claim 1, wherein
a hydrogen-peroxide-water supply line to which a hydrogen peroxide water (H₂O₂) is supplied is branched from the first line, and
the hydrogen-peroxide-water supply line is provided with a valve at a location branched from the first line.

4. The substrate processing apparatus according to claim 1, wherein
a fourth line to which a cleaning water is supplied is connected to the second line, and
the fourth line is provided with a valve at a connection location between the fourth line and the second line.

5. The substrate processing apparatus according to claim 1, wherein
the water supplied from the water supply source to the first line can be discharged from the second line.

6. A substrate processing method performed by a substrate processing apparatus including: a processing part configured to process a substrate; a first line connected to the processing part and a water supply source, the first line being configured to supply a water sent from the water supply source to the processing part; a second line branched from the first line, the second line being provided with a valve at a location branched from the first line; a plurality of third lines branched from the second line, the third lines being respectively provided with valves at locations branched from the second line; and a plurality of chemical-liquid supply sources connected to the respective third lines, the chemical-liquid supply sources being configured to supply chemical liquids to the respective third lines;
the substrate processing method comprising:
performing a chemical liquid process to a substrate in the processing part, by supplying chemical liquids to the processing part by the respective chemical-liquid supply sources through the third lines, the second line, and the first line; and
performing a rinse process to the substrate in the processing part after the performance of the chemical liquid process to the substrate, by supplying the water, which is sent from the water supply source to the first line, to the processing part.

7. The substrate processing method according to claim 6, wherein
a fourth line to which a cleaning water is supplied is connected to the second line, the fourth line being provided with a valve at a connection location between the fourth line and the second line, and
during the rinse process, by opening the valve provided in the fourth line, a cleaning water can be supplied to the processing part from the fourth line through the second line and the first line.

8. The substrate processing method according to claim 6, wherein
the water supplied from the water supply source to the first line can be discharged from the second line, and
during the rinse process, the water supplied from the water supply source to the first line is discharged from the second line.

9. A program executable by a control computer of a substrate processing apparatus including: a processing part configured to process a substrate; a first line connected to the processing part and a water supply source, the first line being configured to supply a water sent from the water supply source to the processing part; a second line branched from the first line, the second line being provided with a valve at a location branched from the first line; a plurality of third lines branched from the second line, the third lines being respectively provided with valves at locations branched from the second line; and a plurality of chemical-liquid supply sources connected to the respective third lines, the chemical-liquid supply sources being configured to supply chemical liquids to the respective third lines;
upon execution of the program, the control computer controlling the substrate processing apparatus to implement a substrate processing method comprising:
performing a chemical liquid process to a substrate in the processing part, by supplying chemical liquids to the processing part by the respective chemical-liquid supply sources through the third lines, the second line, and the first line; and
performing a rinse process to the substrate in the processing part after the performance of the chemical liquid process to the substrate, by supplying the water, which is sent from the water supply source to the first line, to the processing part.

10. A storage medium storing a program executable by a control computer of a substrate processing apparatus including: a processing part configured to process a substrate; a first line connected to the processing part and a water supply source, the first line being configured to supply a water sent from the water supply source to the processing part; a second line branched from the first line, the second line being provided with a valve at a location branched from the first line; a plurality of third lines branched from the second line, the third lines being respectively provided with valves at locations branched from the second line; and a plurality of chemical-liquid supply sources connected to the respective third lines, the chemical-liquid supply sources being configured to supply chemical liquids to the respective third lines;
upon execution of the program, the control computer controlling the substrate processing apparatus to implement a substrate processing method comprising:
performing a chemical liquid process to a substrate in the processing part, by supplying chemical liquids to the processing part by the respective chemical-liquid supply sources through the third lines, the second line, and the first line; and
performing a rinse process to the substrate in the processing part after the performance of the chemical liquid process to the substrate, by supplying the water, which is sent from the water supply source to the first line, to the processing part.
